(19) United States
(12) Patent Application Publication
(10) Pub. No.: US 2013/0206571 A1
(43) Pub. Date: Aug. 15, 2013

(54) PROCESS FOR OBTAINING OILS, LIPIDS AND LIPID-DERIVED MATERIALS FROM LOW CELLULOSIC BIOMASS MATERIALS

(71) Applicants: Steven M. Heilmann, Afton, MN (US); Kenneth J. Valentas, Golden Valley, MN (US); Marc Von Keitz, Minneapolis, MN (US); Frederick J. Schendel, Oakdale, MN (US); Paul A. Lefebvre, St. Paul, MN (US); Michael J. Sadowsky, Roseville, MN (US); Laurie A. Harned, Saint Anthony, MN (US); Lindsey R. Jader, Maplewood, MN (US)

(72) Inventors: Steven M. Heilmann, Afton, MN (US); Kenneth J. Valentas, Golden Valley, MN (US); Marc Von Keitz, Minneapolis, MN (US); Frederick J. Schendel, Oakdale, MN (US); Paul A. Lefebvre, St. Paul, MN (US); Michael J. Sadowsky, Roseville, MN (US); Laurie A. Harned, Saint Anthony, MN (US); Lindsey R. Jader, Maplewood, MN (US)

(21) Appl. No.: 13/703,009

(22) PCT Filed: May 12, 2011
(86) PCT No.: PCT/US11/36184

§ 371 Date: Feb. 20, 2013

Related U.S. Application Data
(60) Provisional application No. 61/334,042, filed on May 12, 2010.

(51) Int. Cl. C10B 53/02; C11B 3/00; C11B 3/02

(52) U.S. Cl. CPC C10B 53/02; C11B 3/02; C11B 3/006
USPC 201/3

(57) ABSTRACT

The present invention concerns low energy requiring methods for processing low cellulosic biomass materials into oil, char and liquid components. One method comprises the steps of subjecting the biomass to hydrothermal carbonization under specified reaction conditions for producing a combined char and oil fraction as well as an aqueous fraction, separating the combined oil and char fraction from the aqueous fraction by filtration; separating the combined oil and char fraction into individual oil and char fractions using an organic solvent for forming an oil depleted char fraction and a liquid oil and solvent solution, and separating the liquid oil and solvent solution into individual oil and solvent fractions by distillation.

### FIELD OF THE INVENTION

The invention herein relates generally to hydrothermal methods for processing low cellulosic biomass materials into usable products and more specifically concerns such methods for extracting lipids and other substances, suitable for conversion to biofuels from such biomass materials.

### BACKGROUND OF THE INVENTION

It is well understood that the combustion of coal and other fossil fuels leads to increased atmospheric acidity, contamination of the air we breathe with ash, soot and heavy metals, and is a major source for the emission of greenhouse gases which contribute to global warming. Thus, continued reliance on coal and other fossil fuels will greatly exacerbate these serious health concerns and environmental impacts. In contrast, combustion of biomass that has not been stored for eons in subterranean reservoirs releases carbon dioxide that is not “new” to the earth's atmosphere and constitutes a carbon neutral event. Biofuels derived from such biomass, in addition to being carbon neutral, can be produced in very pure form essentially without the heavy metals, sulfur and other contaminants that are released into the air during combustion of fossil fuels.

Various plant based biomass sources have been considered, including; corn, wood, sawdust, soybeans, and the like. However, algae are now the focus of increased research attention due to their rapid growth rate and high percentage oil production. Microalgae in particular have unparalleled photosynthetic efficiency, that is, they are highly effective at converting carbon dioxide into biomass. Also, and in contrast to higher terrestrial plants, microalgae are single-celled microorganisms that are non-lignocellulosic in composition, i.e., are not comprised of substantial amounts of substances that are resistant to chemical and biological attack, such as cellulose. Rather, microalgae are composed of proteins, carbohydrates and lipids. The lipid fraction is important because of its potential as an alternate liquid fuel source to replace gasoline, diesel and jet fuels.

The importance of microalgae as a fuel source is underscored by the fact that their photosynthetic efficiency can enable them to actually double their biomass every 3-4 hours during growth phases. Algal oil, comprised of lipids and lipid-derived materials, can approach a content of as much as 50% by weight of cell mass in some species. Projected yields of oil approach 5,000 gallons/acre, and algae can be grown in areas not presently designated as arable land; some can even be grown in seawater. Corresponding yields for high oil-containing terrestrial plant crops such as soybeans, palm and rape seed are at least 15 times lower than algae. Furthermore, algal lipids generally contain fatty acid residues that are in the twelve to sixteen carbon range and, therefore, when converted into hydrocarbon fuels, possess the low freezing points and higher energy densities required for use in diesel and jet aviation fuels.

An initial approach to producing this potential fuel fraction from microalgae required the steps of growing and harvesting the algae, then drying or reducing the amount of water present in order to facilitate the final step of extracting the oil/fuel portion. Each of these steps present a number of technical hurdles with the primary concern being the net energy balance of the entire process. There must obviously not only be a net energy gain, but that gain needs to be substantial if biofuels are to become a commercial success.

One problem concerns the fact that algae grow in water and only achieve low concentrations, e.g., of less than 1% by weight in water. Drying algae therefore requires large amounts of energy, i.e., 2.56 MJ/kg. As a result, an overall negative energy balance is generally observed, i.e., more energy is utilized to obtain the oil than can be generated when combusted as a fuel. For example, a dilute aqueous slurry of algae can be concentrated using centrifugation, flocculation or other methods to achieve water contents of 70-90% depending on the algal species. To extract oil effectively the usual approach is to additionally dry the algal biomass to 10% or less moisture content. The energy consumption in the drying step consumes about 90% of the energy content of the oil when one accounts for the heat required for vaporization and dryer efficiency, without accounting for the energy expended in centrifugation or the energy consumed in subsequent refining of the crude algal oil. Consequently, drying is not an energetically sound technique for obtaining of oil from algae.

The oil extraction step is also energy intensive. Algal oil extraction techniques were initially borrowed from processing systems that are analogous to that developed for the soybean and corn oil industries. Those processes, as applied to algae, involve grinding it to breakdown the cell wall after which the oils are extracted with an organic solvent such as hexane. Grinding and mastication of the biomass materials certainly promotes higher extraction yields, but again, energy is expended in those processes and the energy and cost of the manufacture of the solvent must also be accounted for. In addition, the presence of an organic solvent in the waste that remains after the extraction of the lipids creates a contaminated waste disposal issue, and even trace amounts of the organic solvent may preclude use of the waste algal biomass material as an animal feed.

A further process referred to as “hot extraction” is known and attempts to remove the oil fraction without having to first remove most of the water and not forming char solid in the process. This approach holds out the promise of improving the overall energy efficiency of fuel production from algae by eliminating some of the energy intensive drying steps. This process involves adding a high boiling point organic solvent into a ground algae/water mix after which a solvent/lipid fraction separates therefrom. However, this approach has not been shown to be effective in terms of producing consistently high yields of lipids and may not be effective at obtaining useful lipid-derived materials such as fatty acids from the more intractable lipids such as glyco- and phospholipids. Additionally, the presence of the organic solvents would, as mentioned above, also present contaminated waste disposal problems and prevent use of the residue in animal feed.

Various other hydrothermal processing methods for conversion of algal biomass are known and also have the benefit of circumventing the high energy requiring drying step as the actual conversion process is conducted in water. Hydrothermal Gasification (HTG) is the most thermally severe and has been conducted in the absence of catalysts at 400-800° C. or with Ni and Ru catalysts at 350-400° C. HTG produces a considerable amount of gaseous products including; hydrogen, methane, and carbon dioxide when used on various feed stocks including microalgae.

A further process, Hydrothermal Liquefaction (HTL), is generally conducted at somewhat lower temperatures, e.g. 250-450° C. HTL produces liquid bio-oils, along with relatively small amounts of sticky and difficult-to-process chars, caused by excessive physical breakdown at those temperatures of the cellulosic or non-cellulosic feed stocks, as well as the gaseous byproducts associated with HTG. HTL has also been conducted with microalgae. A significant disadvantage of both of these relatively high temperature hydrothermal methods is that they cause breakdown of the biomass and create carbon dioxide as a reaction product thereby reducing the amount of recoverable liquid and solid fuels.

Less severe reaction conditions, in terms of using lower temperatures and pressures, are employed in a process referred to as Hydrothermal Carbonization (HTC). Lignocellulosic substances, i.e., biomass substances that contain significant quantities of lignin, hemicellulose and cellulose, have been extensively examined as reactants, employing temperatures from 180-250° C. over a period of a few hours to a day. HTC typically results in two product streams that are isolated by filtration: 1) an insoluble char product and 2) water-soluble products.

Generally, with hydrothermal methods, including HTC as applied to lignocellulosic biomass substrates, the desired objective has been to increase the carbon-to-oxygen ratio in the biomass substrate by splitting off carbon dioxide. U.S. Pat. Nos. 5,485,728 and 5,685,153 disclose a wet process referred to as “Slurry Carbonization” that was applied to “low-grade carbonaceous fuels” at conditions with the purpose of causing oxidation to occur and generating carbon dioxide. This carbonization mechanism is undesirable for biofuel production because, with the loss of carbon dioxide, carbon is being depleted as well as oxygen and that would negatively impact the amount and quality of recoverable fuel. Also, creation of gaseous reaction products causes an increase in reaction pressures leading to increased complexity and cost of reaction equipment.

A further problem with biofuel production, and with particular application to the use of algae, concerns the efficient growth of suitable quantities of algae in a commercially sustainable manner. Each batch of algae requires sufficient nutrients to grow quickly and to a sufficient level or density. Thus, the ability to recycle nutrients remaining after oil and/or char extraction is a key factor in making the use of algae-based biofuels a success.

Accordingly, it would be desirable to provide a method of separating algal oil from all of the non-oil components of the algae that overcomes one or more shortcomings of the above-described processes through greater overall energy efficiency, improved yields of fuel and reduction of biomass waste and other by products. It would also be desirable to have a process that yields usable nutrients that can be recycled and used in the growth of subsequent batches of algal biomass feed stocks.

### SUMMARY OF THE INVENTION

The present invention involves a process that subjects a low cellulosic biomass material to hydrothermal carbonization under specific conditions of temperature and pressure. The overall process yields three commercially attractive products: (1) an oil product comprising lipids and lipid-derived materials for conversion to biofuels; (2) an extracted char product that has an energy content equivalent to natural bituminous coal, and (3) an aqueous product that contains most of the nitrogen, phosphorous and potassium originally present in the biomass substrate for recycling as a plant nutrient solution. Preliminary research examining the value of this aqueous liquid phase fraction is contained in our publication S. Heilmann, et al., Applied Energy, in press, and located at www.elsevier.com/locate/apenergy, which publication is incorporated herein by reference thereto.

The source or feed stock materials can include, but are not limited to; low cellulosic biomass materials, such as, microalgae and cyanobacteria as well as fermentation residues, such as distiller's grains produced as a residue byproduct from the fermentation grains and other plant sources initially used to produce fuel ethanol and alcoholic beverages.

The foregoing and other low cellulosic biomass feedstocks can be processed practicing the method of the invention herein to form a combined oil and char fraction and an aqueous or liquid solution or fraction, wherein the basic steps include:
1. Hydrothermally treating the biomass feedstock in a reactor vessel;
2. Separating the resultant combined oil and char fraction from the aqueous fraction;
3. Separating the combined oil and char fraction into separate oil and char fractions.

It was surprisingly found that the lipids and lipid derived materials produced by the process of the present invention were retained in high yield on and within the char and easily recoverable therefrom. It was unexpected that very little if any of the recoverable oil was found to be turned into char during the hydrothermal process of the present invention, especially with the highly unsaturated fatty acids that were present. It was also unexpected that the char would absorb almost all of the fatty acids present and that the major fraction of the fatty acids could be so easily separated from the char. In the process herein it was found that reaction conditions can be controlled to promote hydrolysis of ester functional groups and, it is believed, to increase the yield of lipid-derived materials, especially fatty acids that do not chemically participate in the formation of chars. Rather, fatty acids, thus produced, remain adsorbed onto chars and can be isolated along with the char by filtration and subsequently easily separated therefrom. It is also anticipated that relatively intractable lipid components such as mono and diglycerides, phospholipids, and glycolipids that are also present and contain fatty acid ester functional groups that are hydrolyzed by the process herein into fatty acids and thereby increase the yield thereof.

With respect to the prior art applied to HTC processing of lignocellulosic biomass substrates it is know that such processes take place effectively only in water and can be exothermic causing a potentially dangerous increase in heat and pressure. Also, HTC of lignocellulosic biomass can have carbon efficiencies close to one, i.e., meaning that virtually all the carbon in the biomass substrate ends up as char. Such high carbon efficiencies teach away from the use of a hydrothermal approach to processing biomass for the purpose of producing a usable fuel as all the fuels would be consumed and turned into char. By contrast, the process of the present invention as applied to low cellulosic biomass substrates was found not to be exothermic and, more importantly, provides for reduced carbon efficiencies of ca. 40-60% wherein the oil fraction is not consumed and converted to char.

The findings, that most of the lipids and lipid derivatives produced by the microalgae are absorbed onto and/or into the char, that they are not broken down into shorter chain hydrocarbons or otherwise degraded by the hydrothermal process herein, and that they are easily and economically recovered represents a new opportunity and direction for the algal oil industry.

The production of primarily fatty acids as opposed to glycolipids, i.e. triacylglycerides, is also very desirable result from practicing the process of the invention herein. It is advantageous because separation and purification thereof is easily accomplished by first treating the fatty acids with an aqueous base to form fatty acid carboxylates that are soluble in water. An organic solvent can be added to the system to extract and remove virtually all other impurities. Subsequent acidification can reform the fatty acids that can either crystallize or be extracted in high purity into an organic solvent. Another potential advantage of fatty acid products is that various fatty acids have very dissimilar molecular termini. This should facilitate development of effective industrial catalysts for the conversion of the fatty acids to biofuels. Zeolites are a well known example of heterogeneous catalysts useful for this purpose. As is understood, zeolites can distinguish between these chemically different termini and potentially provide increased yields of conventional hydrocarbon liquid transportation fuels.

With regard to the use of microalgal biomass substrates in the present invention, nutrient recycling is particularly important because algae generally require considerably more nitrogen, almost three times more, than other plants. The overall economics of microalgal growth are therefore considerably improved by the ability to recycle this important nutrient as opposed to continually having to “fertilize” each new growth batch with additional nitrogen. In fact, the critical growth nutrients, such as, nitrogen, phosphorous, and potassium are all found in the liquid portion that remains in the aqueous phase after the separation of the char there from using the process of the present invention. Thus, that aqueous liquid fraction can be put back into the algal cultivation system and used again for growing a subsequent batch of algae. This result not only lowers production cost, but additionally reduces the greenhouse gas footprint due to lower demand for fossil fuel-derived nitrogen fertilizer.

The char that remains after the oil has been extracted can be oxidized as a carbon neutral fuel or can act as a carbon neutral supplement to the burning of natural coal. The char also has utility as a soil amendment; for use as a carbon filter for the purification of water or air, and as a filler and/or reinforcing agent in concrete and polymers. It is also possible that the char can be converted into synthesis gas, also known as “syngas”, for ultimate conversion through well know chemical processes into transportation fuels or industrial chemicals.

### DETAILED DESCRIPTION OF THE DRAWINGS

A better understanding of the structure, function, operation and the objects and advantages of the present invention can be had by reference to the following detailed description which refers to the following figures, wherein:

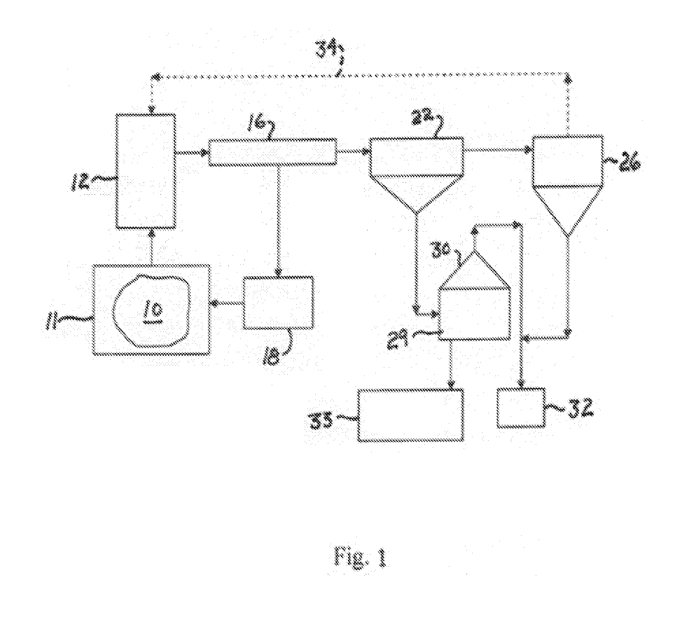

FIG. 1 shows a schematic diagram of the process of the present invention.

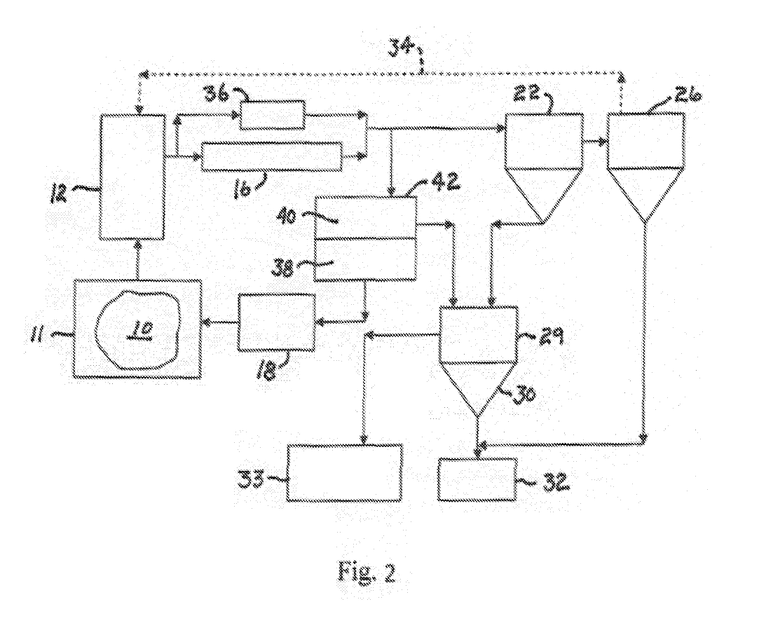

FIG. 2 shows a schematic diagram of a modified process of the present invention.

### DETAILED DESCRIPTION OF THE INVENTION

The present invention provides a process for the conversion of wet, low cellulosic biomass into essentially three useful components: a solid char, a liquid component and lipid and lipid-derived materials (oil) products. Relevant compositional information and utility for the aqueous liquid phase filtrate products are contained in our US nonprovisional patent application, entitled, “Algal Coal and Process for Preparing Same”, application Ser. No. 12/715,595, and in our article in press (S. Heilmann, et al., Applied Energy 2011, in press and available at www.elsevier.com/locate/apenergy); both documents are included herein by reference thereto.

Provided below are terms and phrases with their meaning as used herein in the detailed description of the present invention.

“Lipids” mean triacylglycerides. “Lipid-derived materials” mean fatty acids, mono- and diglycerides, and any hydration or dehydration products created during the process of the present invention. These materials constitute the “oil” products of the invention that are highly desirable. While the lipids and, especially, the lipid-derived materials such as fatty acids comprise the major components of the various extracts that are described, it is anticipated that other materials such as terpenes, sterols, chlorophylls and carotenoids will also be present in the extract solutions. “Low cellulosic” refers to the cellulosic content of a biomass material being generally less than 50% by weight of cellulose and other cellulosic compounds such as hemi-cellulose or lignin. “Char” means and refers to the solid or semi-solid state product formed as a result of the hydrothermal process of the present invention and in particular when such process is applied to low cellulosic material or other suitable biomass material for the production of chars and oils.

Useful low cellulosic biomass substrates for the process of the invention include microalgae, cyanobacteria, fermentation residues, and other materials provided that the cellulose content is generally less than 50% by weight. Carbohydrates are especially reactive under the reaction conditions of the process and useful carbohydrates include mono-, di- and polysaccharides and include: monocarbohydrates such as glucose, galactose, fructose and ribose; dicarbohydrates such as sucrose, lactose and maltose; and polysaccharides such as starch and pectins. Useful fermentation residues include distiller's dried grain with solubles (DDGS), brewer's grain, E. coli fermentation residues, yeast fermentation residues and fungal fermentation residues. DDGS are the residue remaining from the fermentation of grains and other feed stocks used in the production of beverage alcohol. Our co-pending nonprovisional US patent application entitled, “Synthetic Coal and Method of Producing Synthetic Coal from Fermentation Residue”, application Ser. No. 12/941,533, deals with that particular biomass material and is incorporated herein by reference thereto.

“Algae”, “algal” and “algal species” are meant to refer primarily to both naturally occurring and genetically engineered simple unicellular organisms containing chlorophyll, having photosynthetic activity and residing or grown, without limitation, in aquatic and moist terrestrial habitats, in the oceans, and in other environments such as in photobioreactors, in ponds or in man-made raceways. However, algal species can also be grown under fermentation conditions employing heterotrophic growth conditions with glucose, for example, as a source of carbon for growth. These terms may be used somewhat interchangeably and should be understood to include living or dead microalgae from eukaryotic organisms such as, but not limited to, green microalgae. The terms as used herein may also refer to photosynthetic and heterotrophic prokaryotic organisms such as cyanobacteria. The term “microalgae” is meant to refer to microscopic algae, typically found in both fresh and salt water systems. Diatoms that contain a preponderance of silica are useful for obtaining lipids and lipid-derived materials of the invention. A non-exhaustive listing of useful microalgae, which is incorporated herein by reference, can be found at http://wikipedia.org/wiki/SERI_microalgae_culture_collection.

Genetically modified organisms (GMO's) may also provide a possible low cellulosic biomass material. GMO's are being increasingly utilized in fermentation processes, and disposal of the residues can be problematic. Conversion of fermentation residues into the products of the invention will completely eliminate any concern regarding the ultimate disposition/disposal of GMO materials.

A minor amount of cellulose is tolerated and possibly even desirable in useful biomass substrates of the invention. While not wishing to be bound by any mechanistic explanation of the process, it is believed that a majority of the biomass substrate must be solubilized or liquefy in the aqueous environment and undergo substantial carbonization (increasing the carbon-to-oxygen ratio). With lignocellulosic materials that contain lignin, hemicellulose and cellulose, both the lignin and hemicellulose components can be substantially solubilized and undergo carbonization. The cellulose, however, is believed to be largely unaffected under the conditions of the process, except that it may provide a scaffold or solid phase upon which the carbonized components can reassemble and provide the char that is created in the process. Therefore, and in order to observe a relatively high char yield, it may be desirable to have some cellulose present though not a major amount.

The reaction process of the present invention can be understood by referring to the schematic diagram thereof as contained in FIG. 1. The biomass feed stock 10, in this case algae growing in a suitable growth vessel 11, is fed therefrom into a reactor 12 for thermo-treating thereof for the desired period of time. After the algae biomass has been thermally treated it is fed to a filter 16. Filter 16 separates the char/oil combination from the liquid portion. The aqueous liquid portion or filtrate is sent to a tank 18 for storage thereof and from which portions thereof can be returned back to algae vessel 11 to promote growth therein of further algal batches. This option thus provides an aqueous liquid phase product that is unadulterated and can be better recycled as a nutrient solution for plant growth, especially with microalgae. Alternatively, it can be used as an anaerobic digest material, or further processed to isolate or concentrate the nutrient values contained therein to be sold as fertilizer. The char is fed to an extraction apparatus 22. Extractor 22 treats the char/oil combination with a solvent to extract the oils therefrom. The extracted or oil depleted char is sent to be collected and held in a storage tank 26. A combined oil and solvent solution results from this solvent extraction and is sent to be collected in an extractor 29. The combined oil and solvent solution is then separated into separate oil and solvent fractions by distillation apparatus 30. The distilled solvent is then stored in a tank 32 for re-use thereof in subsequent batch separations of further oil containing char. Those of skill will understand that the depleted char can subsequently be subjected to drying in order to collect and recycle any small amounts of solvent that may remain therein which solvent is also directed to tank 32. The oil fraction can be sent from extractor 29 to a storage tank 33. The collected oils can then be processed on site or at another facility, not shown, into liquid transportation fuels. The process is made further energy efficient wherein, before filtration, the reaction products are first cooled with the heat thereof being recycled.

Useful reaction conditions for the conversion of low cellulosic biomass materials in the process of the invention herein are selected such that the primary mechanism for carbonization is accomplished by chemical dehydration especially of hydrocarbon moieties rather than by the loss of carbon dioxide therefrom. Reaction temperatures can range from 170-225° C.; preferably 190-210° C.; and more preferably 200-210° C. Corresponding reaction pressures can range from 1.38-2.41 MPa. Reaction times can range from 0.25 hours (h) to 6 h. Preferably, reaction times range from as short as 0.25 h-2.0 h and typically in the 0.25 h to 1.0 h range. Use of suitable batch processing equipment can achieve good results in the 0.25 to 0.5 h range. Suitable batch processing reactors are of stainless steel construction and are stirred units available from Parr Inc., Moline, Ill. It is anticipated that processing can be accomplished by continuous operation employing scraped wall stainless steel reactors capable of sustaining the above reaction conditions. An example of such continuous reaction equipment is available from Waukesha Chemy-Burrell, Delavan, Wis. Further relevant information regarding process steps and procedures and utility for the various products of the present invention are contained in our copending US nonprovisional patent application, entitled, “Algal Coal and Process for Preparing Same”, application Ser. No. 12/715,595, in our article, S. Heilmann, et al., Applied Energy 2011, in press and available at www.elsevier.com/locate/apenergy); and in our article; Heilmann, et. al., Biomass and Bioenergy, 2010:34:875-882, all of which documents are incorporated herein by reference thereto.

Concentration of the low cellulosic biomass material in the aqueous suspension is important and useful concentration ranges are from 5-30 wt. % for microalgae and cyanobacteria and 15-35 wt. % with fermentation residues. Char yields depend on the concentration of the biomass substrate, i.e., the higher the weight percent of the substrate the higher the char yield; ionic strength of the medium, i.e., adding salts to the medium generally increases yields moderately; and repetitive use of the liquid fraction, i.e., multiple use of the liquid fraction, and the nutrients retained therein, as suspending medium can increase yields. Desired outputs from this portion of the process include the level of carbonization (generally desired to be in excess of 60% carbon), mass yield of the char, and mass yield of oil product, with both the latter desired to be as high as possible. Oil yield will depend on the reaction temperature with higher reaction temperatures generally providing increased amounts of fatty acid products. It is believed that adequate temperatures for essentially completely hydrolyzing triacylglyceride components are provided using the process temperatures of the invention herein.

Carbohydrates are the principal reactants under hydrothermal process conditions and can undergo a chemical dehydration carbonization and char mass growth mechanism that is believed to involve two basic kinds of dehydrations: 1) intra-molecular dehydration in which loss of water within the carbohydrate moiety itself creates carbon-carbon double bonds leading to a substantial increase in the carbon-to-oxygen mass ratio(carbonization) and 2) intermolecular dehydration involving two hydroxyl groups on separate carbohydrate moieties and loss of water resulting in ether linkages, coupling of moieties, and growth of char mass. Carbon-carbon double bonds are also present in many of the lipids and lipid-derived materials present in the system. In particular, multiple double bonds present in one lipid material might be expected to give rise to additional char mass-forming reactions. Such reactions involving compounds containing multiple carbon-carbon double bonds are called cyclo-addition reactions and are of two types: 1) Diels-Alder reactions and 2) Ene reactions. Diels-Alder reactions have shown to be responsible for the efficient addition of vinyl monomers such as acrylic acid during HTC of glucose, and a similar result might be anticipated with unsaturated fatty acids in the presence of carbohydrates within the microalgal reaction medium. Based on this prior art teaching highly unsaturated fatty acids might also be expected to couple and build char mass by a free radical polymerization process that is common to other polyunsaturated compounds. However, these reactions did not occur, or at least were not observed to occur at any significant levels, with the oils or fatty acids resulting from the reaction conditions of the invention herein.

Separating the char, and significant quantities of the associated oil products, from the aqueous liquid phase is conveniently accomplished using conventional direct filtration unit operations. The chars filter quite easily and are generally obtained as free-flowing powders. Centrifugation may also be utilized to separate chars and aqueous liquid phases. One of the unexpected discoveries associated with the process is that substantial quantities of the oil products are bound to the char. Without being bound by theory or belief, this binding is thought to be of two types: 1) In its interior and due to the dehydration reactions that take place, the char has been “carbonized” (increased C:O ratio) relative to starting biomass and is primarily a hydrophobic material. However, the presence of hydrophilic groups such as hydroxyl, carbonyl, carboxyl, and carboxylate groups on the char's surface allow the particles to “wet” in water. Therefore, the bulk of the char is hydrophobic and capable of absorbing hydrophobic oil product materials through hydrophobic-hydrophobic interactions and the principle of “like dissolves like”; and 2) As described in our recent article S. Heilmann, et. al., Biomass and Bioenergy 2011, in press and available on line at www.elsevier.com/locate/biombioe, proteins are also believed to be involved in the chemical reactions taking place such that the surfaces of the chars also contain basic groups such as primary and secondary amine, guanidine and imidazole groups that become protonated and can electrostatically bind anions such as fatty acid carboxylate ions.

With most microalgal substrates, the most efficacious method of isolating high yields of fatty acids is to simply treat the fatty acid/char complex with an organic solvent. Suitable organic extraction solvents include hexane, heptanes, dodecane, Isopar G, diethyl ether and methyl t-butyl ether (MTBE), with MTBE being preferred. If higher yields approaching 95% of the fatty acids present are desired, however, other process operations that can literally glean more fatty acids from the product mixture can be employed. These include optionally treating the char, containing adsorbed oil products, with acids such as hydrochloric, phosphoric and other acids, char separation, followed by organic solvent extraction to remove fatty acids formed from fatty acid carboxylates that may be electrostatically bound thereto and provide additional oil and extracted char. Alternatively, the initial aqueous liquid phase filtrate obtained in the process can optionally be acidified to a system pH of about 4 and extracted with organic solvents to isolate additional fatty acid products. Recovery of the organic solvent and recycling thereof back into the process can be accomplished by distillation, preferably at less than atmospheric pressure to speed the process. The distillation residue, thus obtained, is the oil product of the invention and is suitable for processing into liquid transportation and heating fuels.

In the event that a low cellulosic biomass substrate containing a high concentration of oil, e.g., above 30 weight percent, is utilized, the quantity of fatty acids generated may exceed the adsorption capacity of the char that can be “natively” produced by the particular biomass. When relatively high concentrations of fatty acids are present above the ability of the char to bind or retain them, the chars can become more like “pastes”, presumably because of the high fatty acid content, and become difficult to isolate by filtration. In those instances, depleted chars from a previous hydrothermal reaction process batch that have been separated from the liquid portion and from which the oil and any residual solvent has been removed, can be added back into a subsequent reaction process. This process procedure is seen in FIG. 1 wherein a portion of the depleted char, after the aforementioned drying thereof, can be sent from storage tank 26 into reactor 12, as depicted by dashed line 34. In this manner the added char becomes an additional carrier or absorbent for oil in a subsequent reaction process where the biomass being processed has an oil content that exceeds the carrying capacity of the char that the biomass is capable of producing natively. This approach can serve to resist the formation of sticky hard-to-work with char/oil pastes and permit the use of the lower energy approach of simple filtration of the char followed by solvent extraction of the oil therefrom.

Alternatively, in the case of high oil content biomass, e.g. over 30% by weight volume, it is also possible to place a hydrocarbon solvent that is inert to the hydrothermal conditions within reactor 12 to combine with the reaction mixture. Such hydrocarbon solvents include; hexane heptane, isooctane, dodecane and Isopar G. The purpose thereof is to dissolve some of the significant quantities of oils that are formed during the hydrothermal reaction herein and that are not capable of being fully absorbed by the char that is formed. As seen by also referring to the schematic diagram of FIG. 2, the material resulting from the hydrothermal process can be directed to filter 16 and/or a centrifuge 36 for separation of the char/oil combination from the aqueous portion 38 and from the solvent/oil portion 40. The aqueous portion 38 and the solvent/oil portion 40 are directed to a tank 42 wherein there occurs a phase separation there between which permits their separation into individual components. The aqueous portion 38 can be sent to tank 18 for eventual use in growth vessel 11. The oil/solvent fraction can be directed to tank 29 for separation of the oil therefrom by distillation. The char/oil fraction is sent to extraction apparatus 22, as described above, for solvent separation of the oil therefrom. The solvent/oil portion can also be sent to tank 29 for distillation separation of the solvent from the oil. Those of skill can appreciate that the distillation separation of the oil/solvent combination and the char/oil combination can be subsequent steps.

It was also found that some amounts of lipids and lipid-derived materials can be present in the aqueous filtrate after separation from the char, and can remain in the char after the solvent extraction thereof. In order to increase oil yield it is possible to acidify the aqueous filtrate and/or the char by employing dilute solutions of hydrochloric, phosphoric and other acids to achieve a system pH of approximately 4. The fatty acid carboxylates present in the aqueous filtrate and in the char will be converted into fatty acids that can be extracted by an organic solvent. However, acidification of the aqueous filtrate has the undesired effect of rendering it less useful for recycling of the nutrients therein. This approach also requires an additional step and increases cost due to the use of acids and the disposal of the acidified filtrate.

Treatment of the char/oil combination with acid to a pH of approximately 4 followed by solvent extraction thereof can result in an increased fuel yield. This approach is advantageous compared to acidification of the aqueous filtrate as the filtrate is previously separated from the char before this acidification step and is not adulterated thereby. As described above, the fatty acid carboxylates present in the char will be converted into fatty acids. Subsequent treatment of the char by an organic solvent will remove this now enhanced fatty acid containing oil fraction after which the oil is separated from the solvent by distillation as described herein above. Those of skill will understand that the oil/char fraction can be treated first with solvent to separate the easily removable oil fraction, then with acid to convert any carboxylate moieties to fatty acids followed by a second treatment with solvent to remove that newly formed fatty acid fraction. Use of MTBE is preferred as the acidified char, even though having been washed with water, does not generally require a separate water drying step, as the MTBE has sufficient solvent capacity for both water and the fatty acid solutes present on the char.

It is well understood that the resulting “raw” oil product must be converted into transportation fuels suitable for use as gasoline, diesel and jet fuels. Refining of raw hydrocarbon “crude” oils involves processes, such as, cracking, hydro-cracking, liquefaction, pyrolysis and transesterification. Although this synthetic hydrocarbon chemistry is beyond the scope of this invention, it is known that the most desirable fuels are produced from hydrocarbons in the C12 to C14 chain length; the hydrocarbon chain length of the hydrocarbons easily produced by the present invention. Other objects and advantages of the present invention are further illustrated by the following seven examples, but the particular materials and amounts thereof recited in these examples, as well as other conditions and details, should not be construed as illustrative and not as limiting.

### Example 1

This example illustrates the process of the invention using the species Dunaliella salina as a low cellulosic algal substrate. This alga was obtained as a spray-dried powder from a Chinese source; Qingdao Sinostar Import & Export Co., LTD. This alga which also contains nominally 2% β-carotene was evaluated for extractable lipid content by Minnesota Valley Testing Laboratories (MVTL), located in Minneapolis, Minn., using acid hydrolysis and ether extraction in accordance with the “Association of Analytical Communities” (AOAC) Official Method 996.06 fat; total, saturated, and unsaturated, in foods. This method is utilized to determine what is herein after referred to as the “gravimetric fat value” of alga or other low cellulosic biomass and is expressed as a percentage in weight percent (wt. %). The gravimetric fat value for the fat or lipid content in Dunaliella was 8.5 wt. %, with 2 wt. % being β-carotene. Hydrothermal carbonization of the alga was conducted in a 450 ml Parr stainless steel reactor with stifling at 66 rpm. The Dunaliella powder, 49 g, and distilled water, 150 g, were added to the reactor, and the reactor was sealed. The unit was heated using an inductive heating arrangement to 200° C. for 2 h. When cool, the unit was opened and the contents filtered to remove a char that was washed with water. The solid was freeze-dried to obtain 19.6 g, 40 wt. % mass yield, of char. A portion of the char, 9.54 g, was swirled briefly with 50 ml of hexane and vacuum filtered. Removal of the hexane at reduced pressure using a rotary evaporator left 1.44 g of a brown oil. If the whole char sample had been treated, the extract would have been 2.96 g which is 6.0 wt. % of the mass of the starting alga. This value is very close to the gravimetric fat value of 6.5 wt. % for Dunaliella. 2 wt. % β-Carotene present in the original analysis of the starting alga is believed to have been incorporated into the char since highly unsaturated materials are quite reactive. This was confirmed in a control experiment with β-carotene alone and the formation of a char under the stated reaction conditions. The IR spectrum for the oil showed very strong C═O absorptions supportive of lipids and lipid-derived materials. A small portion of the oil product was converted into fatty acid methyl esters (FAMEs) using the procedure of F. G. Kitson, et al., “Gas Chromatography and Mass Spectrometry: A practical guide”, Academic Press: New York, 1996, p. 337. Gas chromatographic (GC) analysis of the FAMEs indicated the major materials present were as follows: C14:0 (5), C16:0 (1), C18:1 (3), C18:2 (4), and C18:3 (2). Those of skill will understand the nomenclature wherein the number following “C” is the number of carbons in the FAME; the number following the colon is the number of double bonds present; and the parenthetical numbers indicate the relative intensity of the peaks with 1 being most intense. This result corresponds reasonably well with literature reported data for Dunaliella salina (A. Vanitha, et al., Int J Food Sci 2007; 58:373-382). These results support the conclusion that the lipids and lipid-derived materials are primarily present as absorbed materials onto the char. Furthermore, the extracted yields obtained are nearly quantitative based on the gravimetric fat value determined for the starting alga.

### Example 2

This Example teaches that the char created during the process of the invention retains a high level of energy content, despite removal of lipids and lipid-derived materials on extraction. An important issue with the present invention is whether the extracted char retains significant energy content and constitutes an important product of the process or whether most of the energy content is lost in the extraction process. To examine this issue, the heat of combustion of a char derived from Dunaliella salina by the process of the invention in the char produced in Example 1 was submitted to Galbraith Laboratories, Inc., Knoxville, Tenn., for heat of combustion analysis. Similarly, the same char that had been extracted with hexane to remove the lipids and lipid-derived materials was dried and submitted for analysis. The corresponding values were as follows: non-extracted char heat of combustion=12,571 BTU/lb and extracted char=11,881 BTU/lb. In this Example, only 5.5% of the energy content was removed in the extraction step. Therefore, the final extracted char product of the invention retains sufficient energy content to constitute a viable energy product.

### Example 3

This example teaches that the extracts obtained from char products are predominantly lipids and lipid-derived materials. A microalga, Chlorella sp., was obtained from Biocentric Algae, located in San Juan Capistrano, Calif., and used in this example. Hydrothermal carbonization of the material (31.3 g) was conducted as in Example 1 but at 20 wt. % solids, 200° C., and for 2 h. Char mass was 10.02 g and the yield was 32.0 wt. %. Elemental analyses for starting Chlorella was wt. % C=51.6; wt. % H=7.1; and wt. % N=10.1; and for the char was wt. % C=66.2; wt. % H=8.0; and wt. % N=7.3. The char was treated with 0.1 HCl to ensure that all fatty acid products absorbed were in the acid form and extractable. The char was thoroughly washed with distilled water, and the acidified char was freeze-dried. The resulting dry char weight 8.54 g and was swirled with ca. two volumes of methyl-t-butyl ether (MTBE) for an hour. The mixture was vacuum filtered and the filtercake washed with MTBE. Removal of the MTBE using a rotary evaporator provided 2.36 g of a black oil, yield=7.5 wt. % based on starting alga. A ¹H-NMR procedure was developed to measure the molar quantity of methyl esters present in the black oil, relative to an internal standard. The procedure of S. D. House, et al., J. AOAC Int 1194; 77:960-65 was employed using an 8.9% BF₃ methanolic solution to form the fatty acid methyl esters (FAMEs). P-anisic acid was employed as an internal standard for the process. A mixture of p-anisic acid. 0.028 g; 0.18 mmole, and the black oil 0.121 g, were placed in a Teflon capped vial, along with the BF₃/methanol solution (1.55 ml) and benzene (1.55 ml). The resulting greenish solution was sealed and heated at 95° C. for an hour. When cool, water (3 ml) and 10 ml of 50:50 (v/v) benzene:hexane were added. The mixture was vortex mixed for a minute and the upper layer separated using a small separatory funnel. The organic solution was dried over anhydrous sodium sulfate, filtered and concentrated on the rotary evaporator to provide 0.09 g of a brown semi-solid. A solution in benzene-d₆ was prepared at a concentration of 0.009 mg/ml, and the ¹H-NMR spectrum was recorded using a Varian Unity ANOVA NMR spectrometer. The integrated area for the multiplet centered at ca. 8.13 ppm for 2 protons from the p-anisic acid methyl ester internal standard was 20 integration units, while the integrated area for the methyl esters for the FAMEs, minus the aromatic methoxy resonance for the internal standard, from 3.1-3.55 ppm was 56 integration units. This indicated a FAME molar content of 0.50 mmole present in the 0.121 g sample. The FAME composition for a common strain of Chlorella, Chlorella vulgaris, has been reported, S. Otles and R. Pire, J AOAC Int 2001; 84:1708-14, and a weight-averaged molecular weight of about 262 was calculated. The mass of 0.50 mmole would then be 0.131 g which is reasonably close to the 0.121 g charged. Therefore, the NMR determination supports the observation that the oil produced by the process of the invention herein is predominantly FAME in composition.

### Example 4

This example teaches that yields of lipids and lipid-derived materials in excess of the gravimetric fat values may be obtained in certain instances, possibly due to hydrolysis of fatty acid ester residues present in relatively intractable components of low cellulosic biomass substrates such as glycol- and phospholipids. A microalgae species Nannochloropsis sp. was used in the present example and was obtained from XLRenewables, Inc., located in Phoenix, Ariz. The alga was analyzed for gravimetric fat and FAME contents at Medallion Labs. Inc., located in Minneapolis, Minn. The gravimetric fat value was 4.40% and the FAME content 4.45% by weight. Hydrothermal carbonization was conducted at 15 wt. % solids in distilled water, at 200° C. and for 2 h. Yield of the char from the 29.49 g of starting alga was 16.30 g or 55.3 wt. %. Gravimetric fat yield based on the quantity of starting alga should be 1.31 g. A portion, 15.17 g, of the char was extracted with diethyl ether 75 ml and the mixture was allowed to shake gently overnight. Removal of the ether using a rotary evaporator left 1.81 g of a black oil that contained a strong C═O absorption in the infrared at ca. 1750 cm⁻¹, and, if the entire char sample had been extracted, the yield would have been 1.94 g which is an additional 48% compared to the calculated value of 1.31 g from gravimetric fat analysis of the starting alga.

### Example 5

This example teaches that additional increases in yields of lipids and lipid-derived materials can be achieved by acidifying the char prior to extraction. The results obtained in Example 4 is an indication of the quantity of fatty acids that are bound to the char hydrophobically, the present example may also be used as a crude measure of the quantities of those additionally bound by an electrostatic mechanism. In order to obtain a greater quantity of char for extraction, hydrothermal carbonization of Nannochloropsis sp. was conducted at 25 wt. % solids in distilled water, at 200° C. and for 2 h. The char that was obtained on cooling and filtration was washed well with water, and the moist char filter cake was treated with 200 ml of 0.1N HCl. The acidified char product was washed with distilled water, freeze-dried, and weighed 25.63 g (52.3 wt. % yield) from 49.01 g of starting alga (gravimetric fat yield=2.18 g). The acidified char was extracted with 200 ml of MTBE by gentle shaking at room temperature overnight. Removal of the MTBE using a rotary evaporator provided a black oily residue having a strong C═O absorption in the ester region of its infrared spectrum and weighing 4.28 g. Much of the additional 48 wt. % yield observed in this Example compared to Example 4 may be attributed to additional fatty acids electrostatically bound onto the char and that are released for extraction on acidification into an organic solvent.

### Example 6

This example teaches that excellent isolated yields can be obtained by the process of the present invention with microalgae having higher levels of fatty acid content and that is more representative of microalgae that may be utilized by the algal oil industry. The example also teaches that acidification of char and aqueous liquid phase may not be necessary to obtain high isolated yields of fatty acid products. A microalgae of unknown genus and species was received from Inspired Fuels, Inc., Austin, Tex. The material was submitted to Medallion Laboratories for fat analysis (29%) and the calculated weight-average molecular weight of corresponding fatty acid methyl esters (FAMEs) was 290. The process of the present invention was conducted using 5.19 g of the alga at 200° C. for 2 h. Filtration and workup of the char as in previous examples provided 2.25 g of dry char. This was extracted by brief treatment with three volumes of MTBE, filtered, and the filtrate evaporated using a rotary evaporator to obtain 1.59 g of a black oil residue. This oil was analyzed by the NMR procedure of Example 3 except that dimethyl terephthalate was employed as an internal standard. The result was that FAMEs comprised 84% of the mass of the extract or 1.33 g of the theoretical 1.50 g or 89%. The aqueous filtrate was also acidified and extracted with MTBE to provide an additional 0.12 g of fatty acids. Total yield then was 1.45 g (97%) with 89% being obtained from extraction from the char alone. This is a preferred embodiment because the filtrate can remain as initially obtained and not adulterated by any acidification and solvent treatment which could hamper algal nutrient recycle operations.

### Example 7

This example teaches that batch reaction processing conditions as brief as 15 minutes can provide a very acceptable char-forming result and posit that even reaction periods shorter than 15 minutes might be employed using continuous processing methods. The procedure of Example 1 was employed accept that Dunaliella salina was examined at 25% solids, for 15 minutes and at 210° C. A char was isolated in 45.2% yield that possessed a % C level of 64.1% which is a very acceptable result that supports the teaching objective of this example.

Various modifications and alterations of this invention will become apparent to those skilled in the art without departing from the scope and spirit of this invention, and it should be understood that this invention is not to be limited to the illustrative embodiments set forth herein.

We claim:

1. A method for processing biomass materials, comprising the steps of:
hydrothermally treating the biomass materials to produce a combined char and oil fraction and an aqueous fraction,
separating the combined oil and char fraction from the aqueous fraction,
separating the combined oil and char fraction to create a separate oil fraction and a separate char fraction.

2. The method as defined in claim 1 and the combined char and oil fraction separated from the aqueous fraction by filtration.

3. The method as defined in claim 1 and the combined oil and char fraction treated with an organic solvent to create the separate oil and char fractions wherein the solvent and the oil fraction form a liquid oil and solvent solution.

4. The method as defined in claim 3 and further including the step of separating the liquid oil and solvent solution into a separate oil fraction and a separate solvent fraction by distillation.

5. The method as defined in claim 4 and further including the step of collecting and recycling the distilled solvent fraction by reuse in a subsequent process step of separating a liquid oil and solvent solution.

6. The method as defined in claim 1 and treating the combined oil and char fraction with an acid wash after the combined oil and char fraction is separated from the aqueous fraction.

7. The method as defined in claim 1 and further comprising the step of recycling the aqueous portion by reuse thereof in growing further biomass.

8. The method as defined in claim 1 and the step of hydrothermally treating the biomass occurring in a temperature range of from 170 to 225° C.

9. The method as defined in claim 1 and the step of hydrothermally treating the biomass occurring over a time span of from 0.25 to 2.0 hours.

10. A method for processing a low cellulosic biomass, comprising the steps of:
hydrothermally treating the low cellulosic biomass materials to produce a combined char and oil fraction and an aqueous fraction,
separating the combined oil and char fraction from the aqueous liquid fraction by filtration,
extracting a separate oil fraction from the combined oil and char fraction by use of an organic solvent forming a separate char fraction and a separate liquid oil and solvent solution, and
distilling the liquid oil and solvent solution into separate oil and solvent fractions.

11. The method as defined in claim 10 and treating the combined oil and char fraction with an acid wash after the combined oil and char fraction is separated from the aqueous fraction.

12. The method as defined in claim 10 and including the step of adding a hydrocarbon solvent with the low cellulosic biomass while it is being hydrothermally treated to produce a combined char and oil fraction, an aqueous fraction and a liquid hydrocarbon solvent and oil solution, utilizing a phase difference between the aqueous fraction and the liquid hydrocarbon solvent and oil solution to produce a separate aqueous fraction and a separate liquid hydrocarbon solvent and oil solution and separating the liquid hydrocarbon solvent and oil solution into separate hydrocarbon solvent and oil fractions by distillation thereof.

13. The method as defined in claim 10 and the step of hydrothermally treating the biomass in a range of temperatures of from 170 to 225° C.

14. The method as defined in claim 10 and further including the step of hydrothermally treating the biomass occurring over a time span of from 0.25 to 2.0 hours.

15. A method for processing an algal biomass, comprising the steps of:
hydrothermally treating the algal biomass to produce a combined char and oil fraction and an aqueous fraction,
separating the combined oil and char fraction from the aqueous liquid fraction by filtration,
extracting a separate oil fraction from the combined oil and char fraction by use of an organic solvent forming a separate char fraction and a separate liquid oil and solvent solution, and
separating the liquid oil and solvent solution into separate oil and solvent fractions by distillation.

16. The method as defined in claim 15 and treating the combined oil and char fraction with an acid wash after the combined oil and char fraction is separated from the aqueous fraction.

17. The method as defined in claim 15 and including the step of adding a hydrocarbon solvent with the algal biomass while it is being hydrothermally treated to produce a combined char and oil fraction, an aqueous fraction and a liquid hydrocarbon solvent and oil solution, utilizing a phase difference between the aqueous fraction and the liquid hydrocarbon solvent and oil solution to produce a separate aqueous fraction and a separate liquid hydrocarbon solvent and oil solution and separating the liquid hydrocarbon solvent and oil solution into separate hydrocarbon solvent and oil fractions by distillation thereof.

18. The method as defined in claim 17 and further including the steps of treating the combined oil and char fraction with an acid wash after the combined oil and char fraction is separated from the aqueous fraction and subsequently extracting a separate oil fraction from the combined oil and char fraction by use of an organic solvent forming a separate char fraction and a further separate liquid oil and solvent solution, and distilling the further liquid oil and solvent solution into separate oil and solvent fractions.

19. The method as defined in claim 15 and the step of hydrothermally treating the biomass occurring in a range of temperatures of from 170 to 225° C.

20. The method as defined in claim 15 and the step of hydrothermally treating the biomass occurring over a time span of from 0.25 to 2.0 hours.
